(19) United States
(12) Patent Application Publication
(10) Pub. No.: US 2016/0203442 A1
(43) Pub. Date: Jul. 14, 2016

(54) SMART APPOINTMENTS

(71) Applicant: GOOGLE INC., Mountain View, CA (US)

(72) Inventor: Koji PERERIRA, Belo Horizonte (BR)

(73) Assignee: GOOGLE INC., Mountain View, CA (US)

(21) Appl. No.: 14/062,692

(22) Filed: Oct. 24, 2013

(51) Int. Cl. G06Q 10/10

(52) U.S. Cl. CPC G06Q 10/1095

(57) ABSTRACT

A system and method for notifying a user about potential scheduling problems in the user's calendar is disclosed. A calendar system may receive a calendar event that has event details including a title, a date, and a time. Event details may be parsed to determine features of the calendar event. The event details may then be analyzed to determine whether the event details are consistent with previously-stored events, user-specific information, or other known scheduling information. If the event details are inconsistent with known scheduling information, a user may be notified about the inconsistent event details.

### BACKGROUND

Electronic calendars keep track of important events so that users can organize their schedules. The main value of an electronic calendar system is that the system provides a single repository for information regarding a user's scheduled events and important dates. As illustrated in FIG. 1, a user can enter event information into a calendar system including an event date, time, title/name, location/venue, guests, and an event description. For example, a user may schedule tennis with friends. The electronic calendar system then stores this information and, when a user requests calendar information, shows the requested information to the user as shown in FIG. 2.

However, entering event details into the calendar system can be tedious and time-consuming. Manually typed information can also be prone to errors because users may sometimes enter the wrong information. For example, a user may enter the time of a meeting with a manager as 10 pm instead of 10 am. If the user does not find the mistake, she could miss an important meeting. Furthermore, users' schedules may change or need to be updated when new events are either scheduled or occur in users' lives. A user may need to go on an unexpected business trip to London and forget that he has concert tickets in San Francisco during the trip. If the user had remembered, he might have been able to sell the concert tickets.

As recognized by the inventor, a calendar system should contain capabilities that enable the system to minimize wrong data and/or misinformation being input into a calendar and alert users to potential problems with their schedules.

### SUMMARY

This specification describes technologies relating to an electronic calendar system in general, and specifically to methods and systems for automatically notifying a user about potential scheduling problems in the user's calendar.

In general, one aspect of the subject matter described in this specification can be embodied in a system and method for notifying a user about potential scheduling problems in the user's calendar. An exemplary system may include one or more processing devices and one or more storage devices storing instructions that, when executed by the one or more processing devices, cause the one or more processing devices to perform an exemplary method. An exemplary method may include: receiving a calendar event that has event details including at least a title, a date, and a time; parsing the event details to determine features of the calendar event; analyzing the event details to determine whether the event details are consistent with previously-stored events, user-specific information, or other known scheduling information; and responsive to determining that event details are inconsistent, notifying the user about the inconsistent event details.

These and other embodiments can optionally include one or more of the following features: analyzing event details may include parsing user logs to obtain user behavior; determining whether the event details are consistent may include determining the user's location or predicted location at the date and time of the event and comparing the user's location to the event's location; receiving calendar event details may further include receiving an event location at a venue which has business hours; determining whether the event details are consistent includes comparing event details with an event on a second user's calendar who is socially connected to the user; determining whether the event details are consistent may include comparing the event details with a set of rules created based on event details including event type and event location; determining whether the event details are consistent may include comparing the event details with a set of rules created based on general understanding and knowledge of dates and times; notifying the user about the inconsistent event details may include displaying an alert to the user with pre-stored message text; determining whether the event details are consistent may include comparing the event details with a set of rules created from the obtained user behavior; and analyzing event details may include comparing the event time to a venue's business hours.

The details of one or more embodiments of the invention are set forth in the accompanying drawings which are given by way of illustration only, and the description below. Other features, aspects, and advantages of the invention will become apparent from the description, the drawings, and the claims. Like reference numbers and designations in the various drawings indicate like elements.

### BRIEF DESCRIPTION OF THE DRAWINGS

FIG. 1 is a block diagram illustrating a customary calendar event.

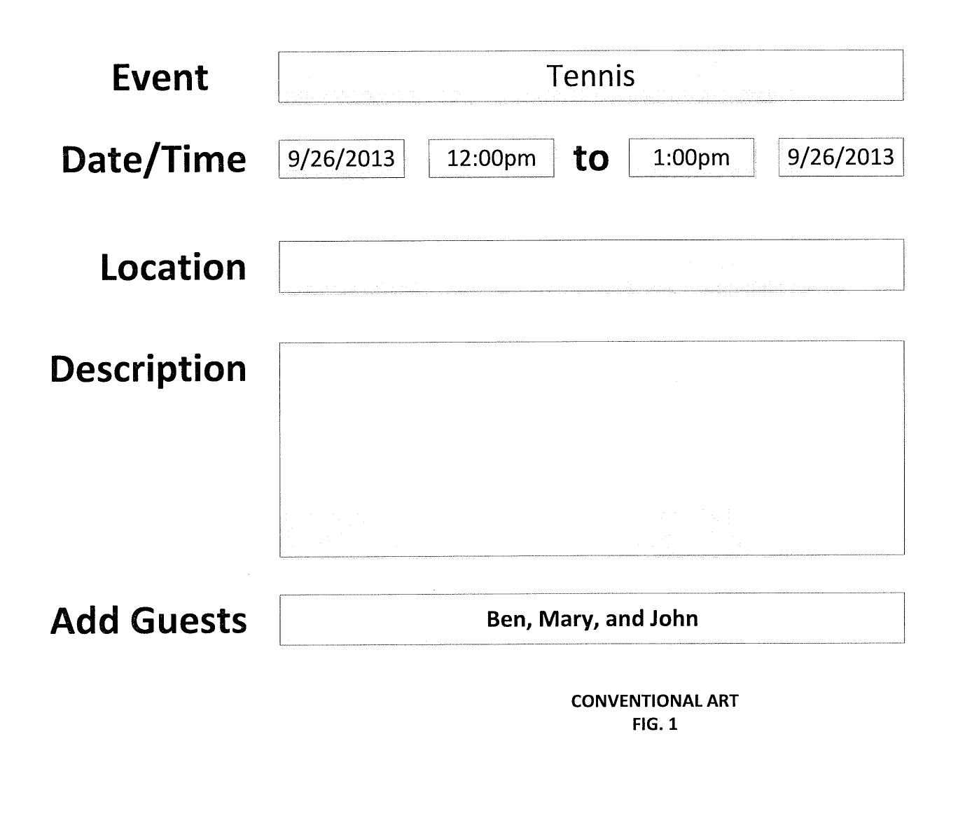

FIG. 2 is a block diagram illustrating a customary calendar display.

FIG. 3 is a flow diagram of an exemplary method for notifying a user about potential scheduling problems in the user's calendar.

FIG. 4 is a block diagram illustrating an exemplary calendar display.

FIG. 5 is a block diagram illustrating an exemplary calendar display.

FIG. 6 is a block diagram illustrating an exemplary calendar display.

FIG. 7 is a block diagram illustrating an exemplary computing device.

### DETAILED DESCRIPTION

According to an exemplary embodiment, an electronic calendar system may determine when a user has entered wrong information into his or her calendar or when the user may have a potential problem with his or her schedule given new information that may affect the user's schedule. The system may then notify the user of potential input mistakes or scheduling problems.

An exemplary system may use user-specific data and/or contextual information to determine whether user-entered events are consistent with a user's routine or general understanding and knowledge of dates and times. Rules may be created from information about a user's behavior, event details, or general scheduling information which may inform an exemplary calendar when a user's calendar has potential input mistakes or scheduling problems. For example, an event type may be a doctor's appointment. A rule may be that appointment events must occur during a defined set of business hours. Some other examples of rules may be: doctor's appointments that are created several times on Wednesdays at 8 am; soccer games that are always created on 7 pm after meetings; a weekly meeting that is always created with the same guests; and a ski trip that is created during holidays. In some embodiments, the exemplary system may determine if previously-input events which are scheduled for the future may be problematic when the system obtains new information regarding a user's schedule.

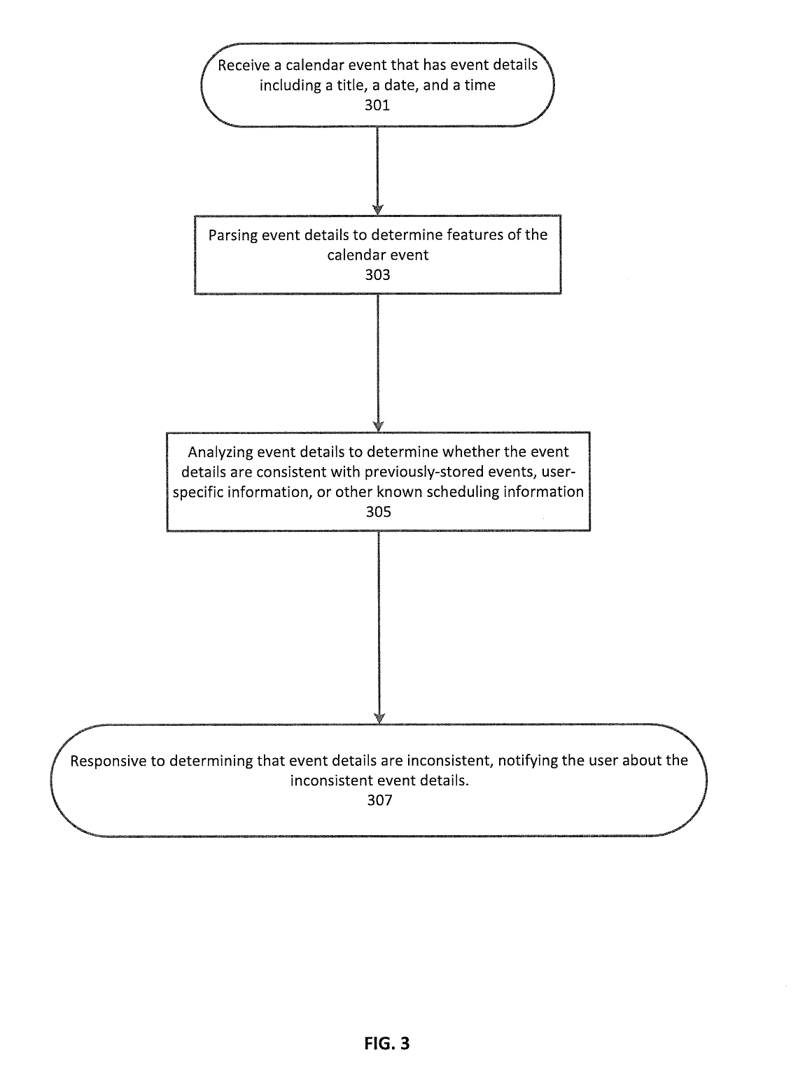

An exemplary method for notifying a user about potential scheduling problems in the user's calendar may begin with receiving a calendar event as shown in FIG. 3 (301). The event details may be parsed to determine the features of the calendar event (303). The type of event may be determined from the features of the calendar event. Event types may include, for example: a meeting, a flight, a vacation, a party, an appointment, or a reservation at a hotel or a restaurant. Event types may be learned by user behavior and/or by analyzing certain properties of an event. For example, if a user creates an event called “studying,” an exemplary system may learn that the user always studies during an 8 am to 7 pm timeframe. This timeframe can then be used to compare new events created with the title “studying.”

The event details may then be analyzed to determine whether the event details are consistent with previously-stored events, user-specific information, people added to the event, or other known scheduling information (305). If the event details are inconsistent, the user may be notified about the inconsistent event details (307).

In an exemplary system, event details may be parsed (303) using artificial intelligence, machine learning, regular expressions, natural language parsing, context-free grammars, or other parsing rules to find text and content that may provide context for events in order to determine whether event details are consistent with general knowledge and understanding of dates and times.

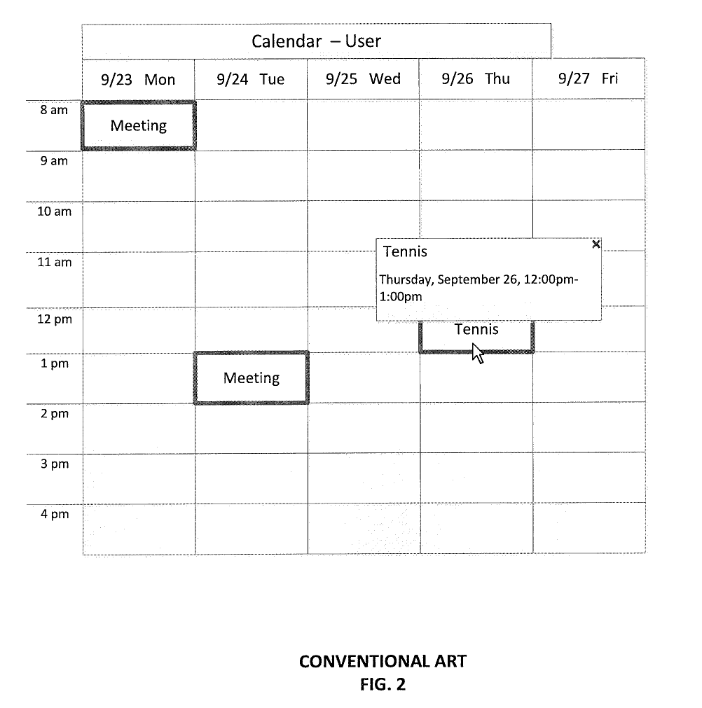

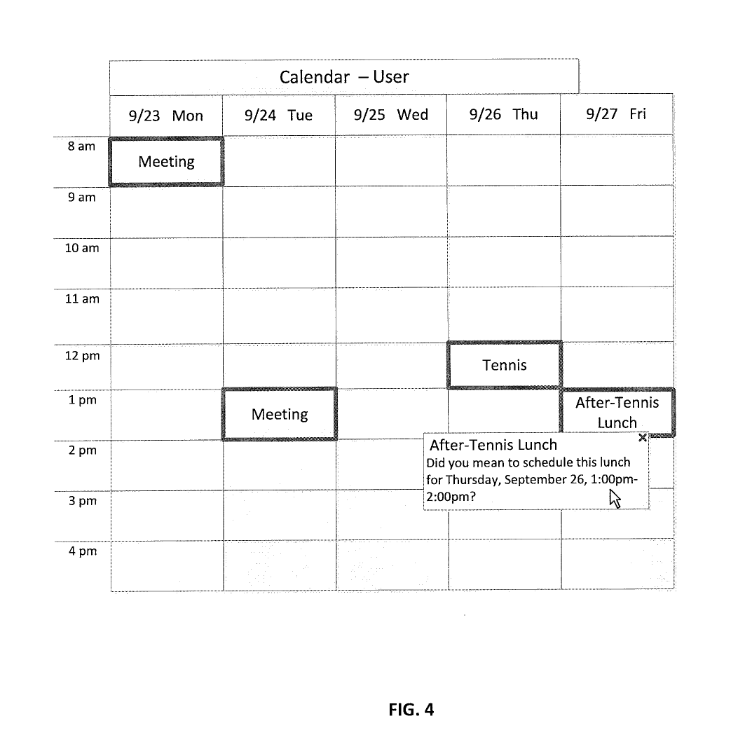

An exemplary system may also compare new event details with previously-stored events to determine whether details entered are consistent with known events. For example, a user may have a tennis event scheduled on his calendar for Thursday, Sep. 26, 2013, as discussed above and shown in FIG. 2. The user may then try to schedule an “after-tennis” lunch. However, the user may enter the lunch for Friday, Sep. 27, 2013 by mistake. An exemplary calendar system may recognize that an “after-tennis lunch” should occur after a tennis event. Therefore, the exemplary calendar system may alert the user to the mistake by displaying a notification to the user about the presumed user error as illustrated in FIG. 4.

In some embodiments, user logs may be parsed to determine typical user behavior. For example, a log may contain GPS information. Based on a user's given location, X, after 9 pm over the course of several days, an exemplary system may learn that a user is at location X if the time is after 9 pm on any given day. A location Y may be 30 minutes from location X. If a user tries to schedule a meeting at location Y for 9:15 pm, an exemplary system may infer that the user may not reach location Y in time for the meeting and propose that the user reschedule the meeting.

Additionally, social signals may be analyzed to create a better understanding of user behavior and a user's social circles. User-specific data may come from sources including a social network or social graph. This data may inform an exemplary system of user-specific information. An exemplary system may understand relationships that the user has with guests of an event, for example guests may be family members, friends, co-workers, or dates. An exemplary system may compare data of the user's social contacts with the user. For example, a user may have an event at the same time in the same place with the same name as a friend's event so all details of the event should match with the friend's calendar event's details. A user's profile may be checked to identify locations frequented by the user such as where the user works, where the user studies, and where the user lives. User data may inform an exemplary system about the user's birthday or the user's contacts birthdays. GPS data may also help an exemplary system understand a user's location. An exemplary system may use a social network or social graph to gather information about a user including photos in which the user was tagged, social check-ins, groups in which the user is a member, and pages the user follows. An exemplary system may also gain information from the user's phone contacts. User-specific information may be used to create a set of user-specific rules which may inform an exemplary calendar when a user's calendar has potential input mistakes or scheduling problems.

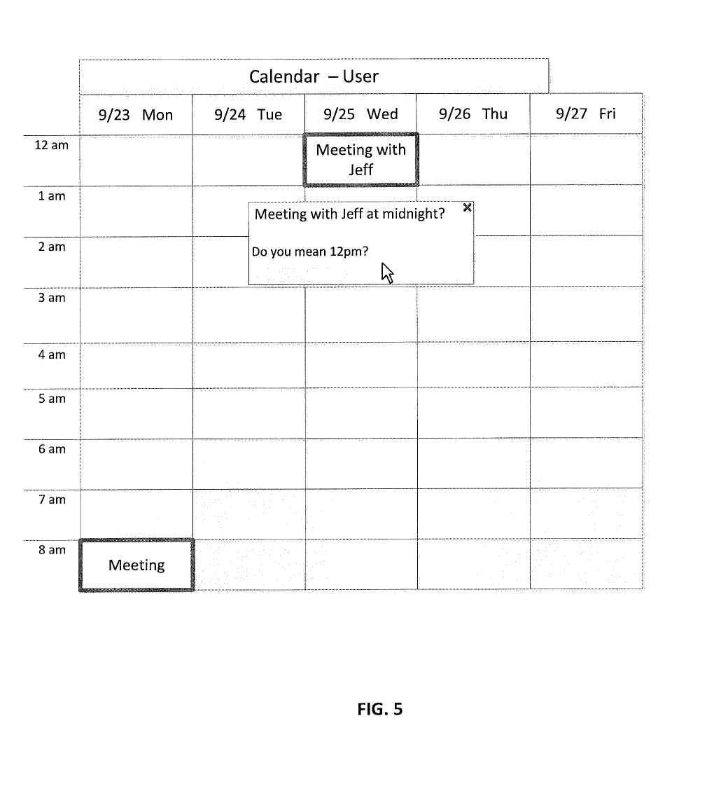

For example, user-specific data may inform an exemplary calendar system that a user, Koji, has a business associate, Jeff. If Koji schedules a meeting with Jeff, the exemplary system may assume that the meeting is a business meeting. If Koji tries to schedule an event entitled “meeting” at 12 am with Jeff as shown in FIG. 5, an exemplary system may assume that this meeting is a business meeting. The system may understand that normal business hours do not occur at 12 am by using pre-stored rules and information. Therefore, an exemplary system may provide the user with a notification or alert the user in some way to the problematic meeting time. An example notification may be an alert with text such as “Business meeting at midnight? Did you mean 12 pm?” An exemplary system may pre-store messages to be used as the notification text. Alternatively, an exemplary system may know that Koji is good friends with Sam. An exemplary system may receive information from an email system regarding Koji and Sam meeting to play pool on Friday night at 11:30 pm. When Koji tries to schedule an event entitled “meeting” with Sam, the exemplary system may not provide an alert or notification since this “meeting” may be assumed to not be a business meeting and may be appropriately scheduled for late evening on Friday.

An exemplary system may be able to determine if events being created or existing events are outside a preferred period based on time periods set up by a user or by an exemplary system using general knowledge and understanding. In an exemplary system, times may be stored in a log and the log may be used to validate new events. Validation information may come from a variety of sources including web pages on the Internet. The Internet may be consulted for user profiles, location information, and national holidays among other information. Information gathered by the exemplary system may be from public websites, private profile information, emails, phone contacts, or other sources of digital information.

A user may set up preferred time periods such as normal business hours or sleeping hours. For example, a user may set 8 am to 5 pm as a preferred time period for business. Alternatively, an exemplary system may use general knowledge of dates and times to determine that Monday through Friday from 9 am to 5 pm are typical normal business hours.

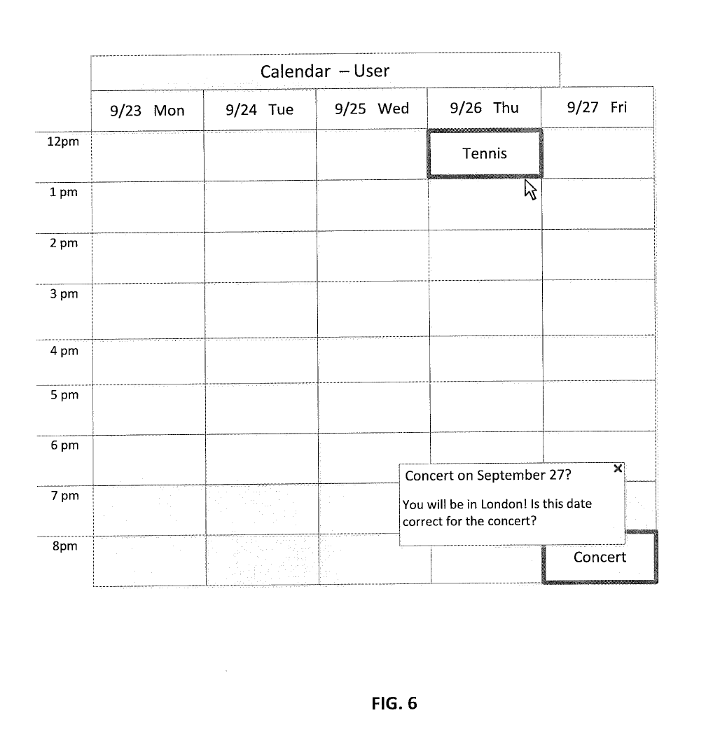

In addition to using natural language information and preferred time periods to determine the appropriateness of an event's details, event details for a new event may be compared to users' locations. For example, a user may try to schedule a concert in San Francisco at the end of September, but an exemplary system may have user-specific data from email or another source which notifies the system that the user will be in London at the end of September. Therefore, the exemplary system may display a notification to the user that the user will not be in San Francisco during the concert as illustrated in FIG. 6. The system may additionally or alternatively ask the user if the concert date is right. One way for an exemplary calendar system to understand where a user was or will be is by knowing the flights the user is taking. Flight confirmations are generally sent via email. An exemplary calendar system may receive flight information or other pertinent user location information from an email system. An exemplary system may also obtain a user's location based on global positioning satellite (GPS) and/or cell tower information from the user's smartphone, cell phone, tablet, or other electronic device. Alternatively, a user may enter location information or define future time zones manually. An exemplary calendar system may allow a user to specify that he will be in a particular location or time zone for a specific date or time range. In some embodiments, an exemplary calendar system may notify a person scheduling an event to the time zones of the event invitees. Locations of event invitees may be determined for example by social data such as check-ins in a social network. The person scheduling the event may then know that a user is not in town for a specific event and be able to reschedule the event without the out of town user having to take action. In order for a calendar system to provide details regarding a user's location, a user may give the exemplary calendar system permission to provide user location information to other calendar users.

An exemplary calendar system may also consider the place of the event when determining whether the event details are reasonable. For example, a user may schedule an event for studying with a tutor at a public library for 11 am on Sunday, specifying the public library and the library's address. However, an exemplary calendar system may determine that the library does not open for business until 1 pm based on general knowledge of the library's hours available on the Internet. Therefore, an exemplary system may notify the user that the library is closed on Sundays until 1 pm. An exemplary notification may be: “The library opens at 1 pm on Sunday. Would you like to reschedule your tutoring time for 1 pm?”

An exemplary system may also consider the current date and time with working days and hours. For example, a user may want to set an alarm for tomorrow morning for work. However, the user may accidently set the alarm for two days from now. An exemplary system may notify the user that the alarm is being set for two days from now and ask the user to verify that the date is correct. An example notification may be “You are setting an alarm for two days from now, did you mean to set the alarm for tomorrow?” Additionally, an exemplary system may consider national holidays, religious holidays, family vacations, or other special days when determining whether user-entered events are consistent with a user's routine or general understanding and knowledge of dates and times.

By using user-specific data and/or other scheduling information, an exemplary calendar system may recognize potential scheduling problems within a user's calendar. An exemplary system's general understanding of date and time information may prevent a user from scheduling a meeting on a holiday or from having concert tickets to a concert in New York when the user is in London. The examples provided are a non-exhaustive list of uses for an exemplary calendar system that notifies a user about potential scheduling problems in the user's calendar.

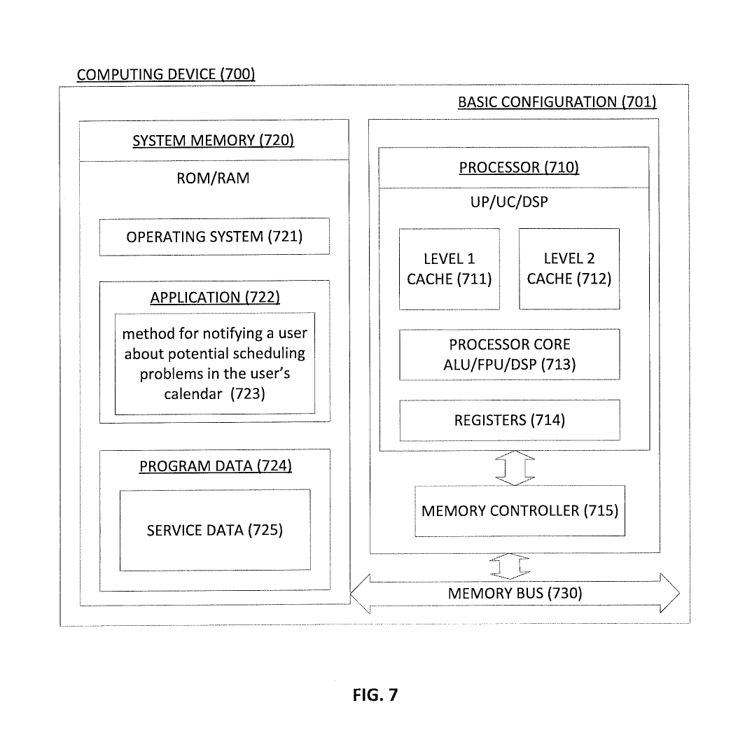

FIG. 7 is a high-level block diagram of an exemplary computer (700) that is arranged for notifying a user about potential scheduling problems in the user's calendar. In a very basic configuration (701), the computing device (700) typically includes one or more processors (710) and system memory (720). A memory bus (730) can be used for communicating between the processor (710) and the system memory (320).

Depending on the desired configuration, the processor (710) can be of any type including but not limited to a microprocessor (μP), a microcontroller (μC), a digital signal processor (DSP), or any combination thereof. The processor (710) can include one more levels of caching, such as a level one cache (711) and a level two cache (712), a processor core (713), and registers (714). The processor core (713) can include an arithmetic logic unit (ALU), a floating point unit (FPU), a digital signal processing core (DSP Core), or any combination thereof. A memory controller (716) can also be used with the processor (710), or in some implementations the memory controller (715) can be an internal part of the processor (710).

Depending on the desired configuration, the system memory (720) can be of any type including but not limited to volatile memory (such as RAM), non-volatile memory (such as ROM, flash memory, etc.) or any combination thereof. System memory (720) typically includes an operating system (721), one or more applications (722), and program data (724). The application (722) may include a system notifying a user about potential scheduling problems in the user's calendar. Program Data (724) includes storing instructions that, when executed by the one or more processing devices, implement a system and method for automatically determining potential scheduling problems in an electronic calendar. (723). In some embodiments, the application (722) can be arranged to operate with program data (724) on an operating system (721).

The computing device (700) can have additional features or functionality, and additional interfaces to facilitate communications between the basic configuration (701) and any required devices and interfaces.

System memory (720) is an example of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media can be part of the device (700).

The computing device (700) can be implemented as a portion of a small-form factor portable (or mobile) electronic device such as a cell phone, a smart phone, a personal data assistant (PDA), a personal media player device, a tablet computer (tablet), a wireless web-watch device, a personal headset device, an application-specific device, or a hybrid device that include any of the above functions. The computing device (700) can also be implemented as a personal computer including both laptop computer and non-laptop computer configurations.

In situations in which the system discussed here collects personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the server that may be more relevant to the user. In addition, certain data may be treated in one or more ways before it is stored or used so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers, as one or more programs running on one or more processors, as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of non-transitory signal bearing medium used to actually carry out the distribution. Examples of a non-transitory signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium. (e.g., a fiber optic cable, a waveguide, a wired communications link, a wireless communication link, etc.)

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method for notifying a user about potential scheduling problems in the user's calendar comprising:
creating scheduling rules from information based on a user's behavior;
receiving a calendar event that has event details including at least a title, a date, and a time;
parsing the event details to determine features of the calendar event;
analyzing the event details to determine whether the event details are consistent with scheduling rules created from information about a user's behavior; and
responsive to determining that event details are inconsistent, notifying the user about the inconsistent event details.

2. The computer-implemented method of claim 1, wherein analyzing event details includes parsing user logs to obtain user behavior.

3. The computer-implemented method of claim 1, wherein determining whether the event details are consistent includes determining the user's location or predicted location at the date and time of the event and comparing the user's location to the event's location.

4. The computer-implemented method of claim 1, wherein receiving calendar event details further includes receiving an event location at a venue which has business hours.

5. The computer-implemented method of claim 1, wherein determining whether the event details are consistent includes comparing event details with an event on a second user's calendar, and wherein the second user is socially connected to the user.

6. The computer-implemented method of claim 1, wherein determining whether the event details are consistent includes comparing the event details with a set of rules created based on event details including event type and event location.

7. The computer-implemented method of claim 1, wherein determining whether the event details are consistent includes comparing the event details with a set of rules created based on general understanding and knowledge of dates and times.

8. The computer-implemented method of claim 1, wherein notifying the user about the inconsistent event details includes displaying an alert to the user with pre-stored message text.

9. The computer-implemented method of claim 2, wherein determining whether the event details are consistent includes comparing the event details with a set of rules created from the obtained user behavior.

10. The computer-implemented method of claim 4, wherein analyzing event details includes comparing the event time to the venue's business hours.

11. A system for notifying a user about potential scheduling problems in the user's calendar, the system comprising:
one or more processing devices; and
one or more storage devices storing instructions that, when executed by the one or more processing devices, cause the one or more processing devices to:
create scheduling rules from information based on a user's behavior;
receive a calendar event that has event details including at least a title, a date, and a time;
parse the event details to determine features of the calendar event;
analyze the event details to determine whether the event details are consistent with scheduling rules created from information about a user's behavior; and responsive to determining the event details are inconsistent, notify the user about the inconsistent event details.

12. The system of claim 11, wherein analyzing event details includes parsing user logs to obtain user behavior.

13. The system of claim 11, wherein determining whether the event details are consistent includes determining the user's location or predicted location at the date and time of the event and comparing the user's location to the event's location.

14. The system of claim 11, wherein receiving calendar event details further includes receiving an event location at a venue which has business hours.

15. The system of claim 11, wherein determining whether the event details are consistent includes comparing event details with an event on a second user's calendar and wherein the second user is socially connected to the user.

16. The system of claim 11, wherein determining whether the event details are consistent includes comparing the event details with a set of rules created based on event details including event type and event location.

17. The system of claim 11, wherein determining whether the event details are consistent includes comparing the event details with a set of rules created based on general understanding and knowledge of dates and times.

18. The system of claim 11, wherein notifying the user about the inconsistent event details includes displaying an alert to the user with pre-stored message text.

19. The system of claim 12, wherein determining whether the event details are consistent includes comparing the event details with a set of rules created from the obtained user behavior.

20. The system of claim 14, wherein analyzing event details includes comparing the event time to the venue's business hours.
